(19) United States
(12) Patent Application Publication
(10) Pub. No.: US 2026/0292790 A1
(43) Pub. Date: Sep. 24, 2026

(54) APPARATUS AND METHOD FOR HANDLING INTERLACING OF PHYSICAL RESOURCE BLOCKS IN A SIDELINK COMMUNICATION

(71) Applicant: Lenovo (Singapore) Pte. Limited, Singapore (SG)

(72) Inventors: Karthikeyan Ganesan, Kronberg Im Taunus (DE); Alexander Golitschek Edler von Elbwart, Darmstadt (DE)

(73) Assignee: Lenovo (Singapore) Pte. Limited, Singapore (SG)

(21) Appl. No.: 19/111,718

(22) PCT Filed: Sep. 28, 2023
(86) PCT No.: PCT/IB2023/059729

§ 371 Date: Mar. 13, 2025

Related U.S. Application Data
(60) Provisional application No. 63/411,226, filed on Sep. 29, 2022.

(51) Int. Cl. H04W 72/04

(52) U.S. Cl. CPC H04W 72/04

(57) ABSTRACT

An apparatus and method are provided where an interlaced based resource block configuration is received which includes a physical resource block mapping for one or more bandwidth parts. Each bandwidth part includes a plurality of resource block sets each having a first defined size for mapping a plurality of subchannels of a second defined size into the respective resource block set, where the second defined size does not divide evenly into the first defined size. One or more remaining physical resource blocks that number less than the second defined size remain unassigned after a maximum number of subchannels are created. The remaining physical resource blocks from the plurality of resource block sets are aggregated. Additional subchannels, which have the second defined size, are defined from the aggregated remaining physical resource blocks, where the additional subchannels include resource blocks which span multiple resource block sets.

### FIELD OF THE INVENTION

The present disclosure is directed to the handling of the interlacing of physical resource blocks in a sidelink communication, and more particularly to the management of the interlacing for physical resource blocks that are remaining in a resource block set after one or more subchannels are defined, therein.

### BACKGROUND OF THE INVENTION

Presently, user equipment, such as wireless communication devices, communicate with other communication devices using wireless signals, such as within a network environment that can include one or more cells within which various communication connections with the network and other devices operating within the network can be supported. Network environments often involve one or more sets of standards, which each define various aspects of any communication connection being made when using the corresponding standard within the network environment. Examples of developing and/or existing standards include new radio access technology Long Evolution (LTE), Universal Mobile (NR), Term Telecommunications Service (UMTS), Global System for Mobile Communication (GSM), and/or Enhanced Data GSM Environment (EDGE).

As part of functioning within many communication networks, such as cellular communication networks, a large part of supporting communications can often involve the use of spectrum resources, that are largely auctioned/licensed for use to a specific service provider through appropriate governing authorities. The amount of licensed spectrum that a service provider has obtained the rights to use often correlates to the overall amount of information throughput that can be more directly supported. As a way of expanding capabilities and information throughput, service providers have been increasingly looking toward unlicensed frequencies, that are available for general use, as a way to support enhanced functionality and communication throughput.

Communications in an unlicensed portion of the spectrum can sometimes involve a form of communication referred to as listen before talk (LBT). In LBT, a radio transmitter will often sense the radio environment for activity from other sources in the radio channel space of interest (listen), before attempting to transmit (talk), after the radio channel space is determined to be relatively clear of other already existing communications. In order to determine whether a particular radio channel is clear, when listening to the channel space, a channel space's power spectral density and minimum channel occupancy may be considered as part of a clear channel assessment.

In at least some instances, a channel space may be subdivided into one or more subchannels, and in at least some of these instances, the size of the subchannel may not divide evenly into the size of the channel space. This can sometimes result in a few resource elements that are present in the channel space, that do not belong to any of the defined subchannels. These are sometimes called irregular or remaining physical resource blocks. If these resources remain undefined they will sometimes go unused, even if a device is making use of a particular channel space. In turn, these unused resource may contribute to the channel space's power spectral density and minimum channel occupancy, which could deflate the perceived usage of the channel. If the perceived usage falls below a predefined usage threshold, such as a channel occupancy of 80 percent, the channel may be determined to be no longer be in use, and may be deemed to be available for another device to make use of this channel space.

The present inventors have recognized that it may be possible to better organize the use of a channel space, so as to reduce the amount of unused irregular or remaining physical resource blocks that are present in a particular channel space being used by a device, as well as better manage the positioning of these resource blocks including the interleaving of the physical resource blocks associated with one or more (sub) channels in a particular channel space, so as to reduce the possible misperception, that a channel space may not be in use.

### SUMMARY

The present application provides a user equipment (UE). The UE includes at least one controller coupled with at least one memory and configured to cause the UE to receive an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The remaining physical resource blocks are aggregated from the plurality of resource block sets, and one or more additional subchannels are defined, which have the second defined size from the aggregated remaining physical resource blocks, where any one of the additional subchannels includes resource blocks which span multiple resource block sets. An indication is provided of an interlace for each of the one or more additional subchannels, which have been defined from the aggregated remaining physical blocks which span multiple resource block sets.

According to another possible embodiment, a processor for wireless communication in a user equipment (UE) is provided. The processor includes at least one controller coupled with at least one memory and configured to cause the UE to receive an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The remaining physical resource blocks are aggregated from the plurality of resource block sets, and one or more additional subchannels are defined, which have the second defined size from the aggregated remaining physical resource blocks, where any one of the additional subchannels includes resource blocks which span multiple resource block sets. An indication is provided of an interlace for each of the one or more additional subchannels, which have been defined from the aggregated remaining physical blocks which span multiple resource block sets.

According to a further possible embodiment, a network entity is provided. The network entity includes at least one controller coupled with at least one memory and configured to cause the network entity to transmit an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The remaining physical resource blocks are aggregated from the plurality of resource block sets, and one or more additional subchannels having the second defined size are defined from the aggregated remaining physical resource blocks, where any one of the additional subchannels includes resource blocks which span multiple resource block sets. An indication of an interlace is provided for each of the one or more additional subchannels, which have been defined from the aggregated remaining physical blocks which span multiple resource block sets.

According to a still further possible embodiment, a method in a user equipment is provided. The method includes receiving an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The remaining physical resource blocks from the plurality of resource block sets are aggregated. One or more additional subchannels, which have the second defined size, are defined from the aggregated remaining physical resource blocks, where any one of the additional subchannels includes resource blocks which span multiple resource block sets. An indication of an interlace is provided for each of the one or more additional subchannels, which have been defined from the aggregated remaining physical blocks which span multiple resource block sets.

These and other features, and advantages of the present application are evident from the following description of one or more preferred embodiments, with reference to the accompanying drawings.

### BRIEF DESCRIPTION OF THE DRAWINGS

FIG. 1 is a block diagram of an exemplary network environment in which the present invention is adapted to operate;

FIG. 2 is an exemplary resource pool structure;

FIG. 3 is an exemplary interlacing structure for a 20 Mhz LTE channel;

FIG. 4 is an exemplary interlace mapping for a 100 physical resource block set of a 20 MHz channel, which includes 8 subchannels, each having a size of 12 resource blocks;

FIG. 5 is an exemplary interlace mapping for a 100 physical resource block set of a 20 MHz channel, which includes 6 subchannels, each having a size of 15 resource blocks;

FIG. 6 is an aggregated subchannel mapping for three physical resource block sets;

FIG. 7 is an interlacing configuration for the defined subchannels for three aggregated physical resource block sets;

FIG. 8 is a chart highlighting the presence and position of the subchannel index in a resource block set; and

FIG. 9 is a flow diagram in a user equipment the handling of the interlacing of physical resource blocks in a sidelink communication;

FIG. 10 is a flow diagram in a network entity the handling of the interlacing of physical resource blocks in a sidelink communication; and

FIG. 11 is an exemplary block diagram of an apparatus according to a possible embodiment.

### DETAILED DESCRIPTION OF THE PREFERRED EMBODIMENT(S)

While the present disclosure is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

Embodiments provide support for the management of the usage of physical resource blocks in a resource block set, as well as the handling of the interlacing of physical resource blocks as part of a sidelink communication in an unlicensed portion of the spectrum.

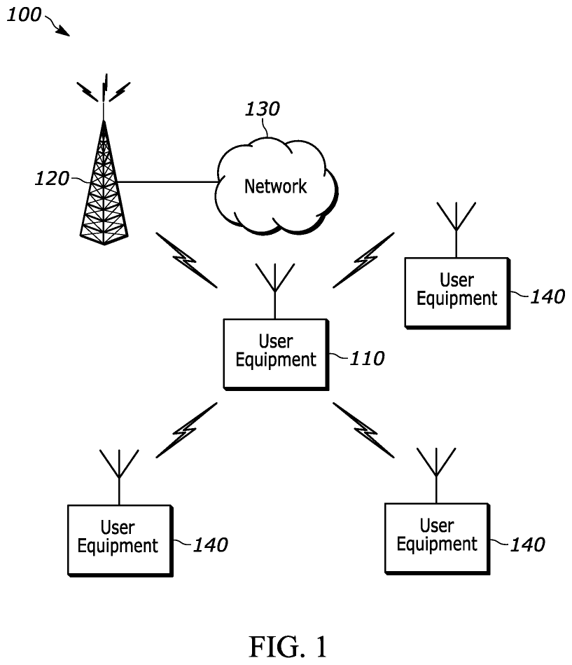

FIG. 1 is an example block diagram of a system 100 according to a possible embodiment. The system 100 can include a wireless communication device 110, such as User Equipment (UE), a base station 120, such as an enhanced NodeB (eNB) or next generation NodeB (gNB), and a network 130.

The wireless communication device 110 can be a wireless terminal, a portable wireless communication device, a smartphone, a cellular telephone, a flip phone, a personal digital assistant, a personal computer, a selective call receiver, a tablet computer, a laptop computer, or any other device that is capable of sending and receiving communication signals on a wireless network.

The network 130 can include any type of network that is capable of sending and receiving wireless communication signals. For example, the network 130 can include a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 5th generation (5G) network, a 3rd Generation Partnership Project (3GPP)-based network, a satellite communications network, a high altitude platform network, the Internet, and/or other communications networks.

In addition to and/or alternative to communicating with the network 130, the wireless communication device 110 may sometimes be able to communicate more directly with other wireless communication devices, such as user equipment 140. An example of this type of communication can sometimes be called peer-to-peer, and can sometimes relate to a sidelink type communication. In some instances, this can involve a targeted communication with a single entity, which is sometimes referred to as a unicast. In some instances, this can involve a targeted communication with multiple entities, which is sometimes referred to as a multi-cast. In some instances, this can involve an untargeted communication, which is available to any entity within transmission/reception range, which is sometimes referred to as a broadcast. In the illustrated embodiment, the base station 120 and the other user equipment 140 are potential communication targets of the wireless communication device 110.

Sidelink unlicensed operation is gaining momentum in Rel18 work item in the 3rd Generation Partnership Project (3GPP) and the transmission over the unlicensed spectrum for channels such as physical uplink shared channel (PUSCH), physical uplink control channel (PUCCH) format 2 etc., should meet the power spectral density (PSD) regulation and minimum channel occupancy (e.g., 80%). To fulfill these regulations, interlacing methods were defined in LTE-unlicensed and NR-unlicensed by interlacing PUSCH and PUCCH channels at resource block level. Sub-physical resource block (PRB) based interlacing was discussed during NR Rel16 considering higher subcarrier spacing (SCS), but eventually no agreement was reached.

In NR Rel16 sidelink resource allocation, the minimum scheduling unit is defined by sub-channels consisting of ‘N’ PRBs and ‘M’ sub-channels constitute a resource pool. Each sidelink (SL) carrier contains one SL bandwidth part (BWP) which is then associated with multiple transmit (Tx) Resource pools containing different configuration of the sub-channel sizes {n10, n12, n15, n20, n25, n50, n75, n100}. The minimum scheduling unit of sub-channel for sidelink contradicts that of uplink which is based on a resource block (RB) level scheduling unit and each resource pool in the sidelink does not span across the entire bandwidth or LBT subbands, which is the requirement for minimum occupancy and PSD limits. In order to meet the regulatory requirements of PSD and the minimum channel occupancy (i.e. 80%) for sidelink unlicensed operation requires the study of new interlacing methods by considering the traditional sidelink design of sub-channels and resource pools.

A further concern involves the issue of how to handle irregular or remaining PRBs (i.e., in instances where their number is not large enough for a full subchannel) in Rel-18 for UE scheduling and as part better managing the overall resource efficiency. Further considerations include-how to signal the interlacing index for those irregular PRBs and which PRBs needs to be considered for the irregular PRBs. A further consideration is that one subchannel may be equal to k interlaces and the value of k may be preconfigured in a resource pool, which implies that one subchannel size may be equal to one interlace, and another option, one subchannel size may be equal to more than one interlace. In the case of one subchannel size being equal to k interlaces, then there will be issues on how to handle the remaining PRBs or irregular PRBs in the interlace design within one subchannel, which is similar to the issue, as described above.

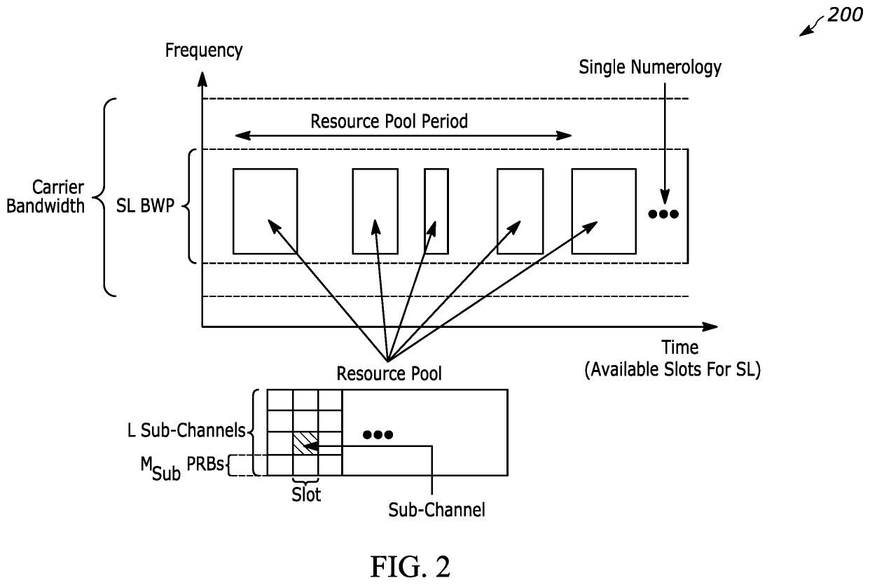

NR sidelink designed as part of Rel16 defines a resource pool structure within the SL BWP in a SL carrier. One or more resource pool structure (pre) configuration in 3GPP TS 38.331 contains subchannel size, and a bitmap of time slot and frequency resource as seen in FIG. 2. FIG. 2 illustrates an exemplary resource pool structure 200.

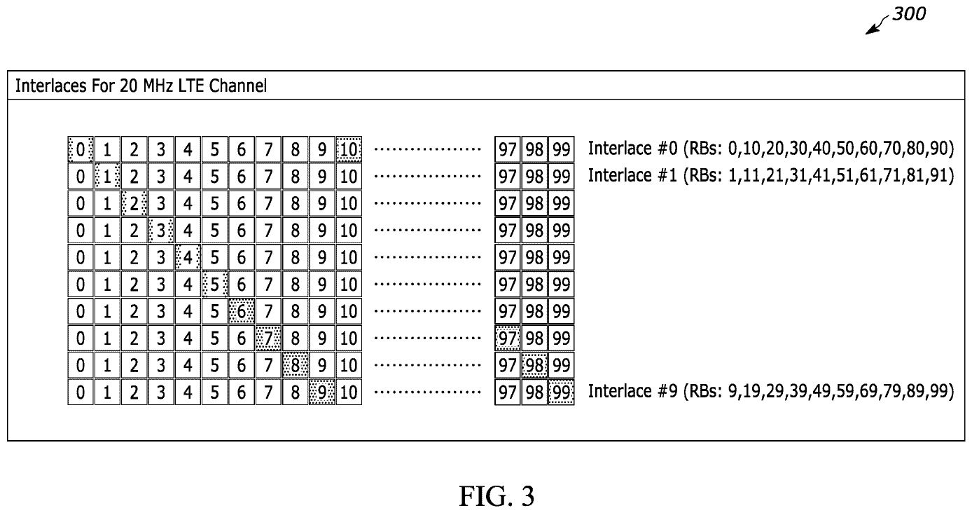

An interlace design is introduced as part of LTE licensed-assisted access (LAA) and NR-unlicensed operation in Rel16 to meet the PSD regulation and minimum channel occupancy (e.g., 80%). For a 20 MHz wide LTE channel, corresponding to 100 RB, there are ten interlaces with 10 RB per interlace. Interlace #0 contains resource blocks {0, 10, 20, 30, 40, 50, 60, 70, 80, 90}, as seen in FIG. 3. FIG. 3 illustrates an exemplary interlacing structure 300 for a 20 Mhz LTE channel.

Below are some of the NR Rel16 agreements about interlace design for uplink (UL) considering PUSCH and PUCCH transmission.
For interlaced PUSCH transmission in a BWP, X bits of the PUSCH frequency domain resource allocation field are used for indicating which combination of M interlaces is allocated to the UE.
This applies to PUSCH of the following types:
   Msg3 PUSCH
   PUSCH Scheduled by fallback and non-fallback DCIType 1 and Type 2 Configured Grant PUSCH
For 30 kHz SCS
   Support X=5 (5-bit bitmap to indicate all possible interlace combinations)
For 15 kHz SCS
   Down-select between the following two alternatives:
   Alt-1: Support X=10 (10-bit bitmap to indicate all possible interlace combinations)
   Alt-2: Support X=6 bits to indicate start interlace index and number of contiguous interlace indices (RIV) and using remaining up to 9 RIV values to indicate specific pre-defined interlace combinations

From the RAN1 #98 agreement on interlace indication for PUSCH for 15 kHz SCS, Alt-2 is selected:
Support X=6 bits to indicate start interlace index and number of contiguous interlace indices (RIV) and using remaining up to 9 RIV values to indicate specific pre-defined interlace combinations
RIV values from 0 . . . 54 indicate start interlace index and number of consecutive interlace indices
RIV values from 55 . . . 63 indicate the following interlace combinations (from 36.213):

| RIV | Interlace Indexes |
|---|---|
| 55 | 0, 5 |
| 56 | 0, 1, 5, 6 |
| 57 | 1,6 |
| 58 | 1, 2, 3, 4, 6, 7 ,8, 9 |
| 59 | 2,7 |
| 60 | 2, 3, 4, 7, 8, 9 |
| 61 | 3, 8 |
| 62 | 4, 9 |
| 63 | Reserved |

Below are some of the NR Rel18 agreements on sidelink unlicensed (SL-U)

For PSCCH and PSSCH in SL-U:
For interlace RB-based transmission
   Frequency domain resource allocation granularity is one sub-channel for PSSCH transmission
   sub-channel equals K interlace
      FFS: whether K is fixed as 1 or (pre-) configured
   Discuss whether one or both of the following alternatives are supported
      Alt 1:1 sub-channel is confined within 1 RB set
      Alt 2:1 sub-channel spans 1 or multiple RB set(s) belonging to a resource pool

TABLE
Max trasmission bandwidth configuration number of resource
blocks (N_{RB} for frequency range 1 (FR1) - 450-7125 MHz

| | 5 | 10 | 15 | 20 | 25 | 30 | 40 | 50 | 60 | 80 | 100 |
|---|---|---|---|---|---|---|---|---|---|---|---|
| SCS | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A |
| 30 | 11 | 24 | 38 | 51 | 65 | 78 | 106 | 133 | 162 | 217 | 273 |
| 60 | N/A | 11 | 18 | 24 | 31 | 38 | 51 | 65 | 79 | 107 | 135 |

From this table, we can see that the number of resource blocks in a resource block set can vary. For example for a 20 MHz wide channel having a subcarrier spacing of 15 kHz, a total of 106 resource blocks may be available.

According to the first embodiment, for the interlaced RB based transmission for physical sidelink control channel (PSCCH) and physical sidelink shared channel (PSSCH) transmission in sidelink-unlicensed (SL-U), the frequency domain resource allocation granularity is one subchannel, and the number of subchannels in a RBset, corresponding to one LBT subband, varies according to the subchannel size and the SCS. As we can see from the below Table 1, for 15 kHz SCS and subchannel size 12, 15 and 75 PRBs, and Table 3 for 30 kHz SCS and subchannel sizes 12, 15 and 20 PRBs, some of the PRBs belonging to a RBset not meeting the PRB requirement for a full subchannel size are named as ‘remaining PRBs’. In some cases, such as for Tables 2 and 4, where the size of the resource pool are a little more irregular, remaining PRBs may be present in most instances for the various possible subchannel sizes.

The present application discusses various embodiments associated with the handling of the remaining PRBs. However, the number of remaining PRBs can vary depending upon several factors including the size, namely number of PRBs in each subchannel, the number of PRBs in the resource pool. The present application also describes a similar method to handle, when one subchannel size may be equal to k interlaces and the value of k may be preconfigured in a resource pool, which implies that one subchannel size may be equal to one interlace or one subchannel size may be equal to more than one interlace. In the case of one subchannel size being equal to one interlace, then the subchannel size equals the number of PRBs in each interlace, which is shown in the below tables. When one subchannel size equals more than one interlace, then each subchannel size is further divided into k interlaces, and in some cases, there will be remaining PRBs or irregular PRBs within each subchannel that may need to be handled in similar method as that of the handling of the remaining PRBs or irregular PRBs within each resource block set. So, the method and procedure described to handle remaining PRBs or irregular PRBs within each resource block set is equally applicable for handling the remaining PRBs or irregular PRBs within each subchannel, when there are more than one interlace formed from a subchannel.

Table 1, identifies for a resource pool having a 20 MHz Bandwidth with 100 PRBs at 15 KHz sub-carrier spacing, for each of a number of different subchannel sizes, a number of sub-channels and a number of remaining PRBs, if any.

| | No of sub-channels in a | Remaining |
|---|---|---|
| | resource pool with | PRBs (less than |
| Subchannel | 20 MHz BW (100PRBs | the subchannel |
| size (PRBs) | @15 KHz SCS) | size) |
| 10 | 10 | 0 |
| 12 | 8 | 4 |
| 15 | 6 | 10 |
| 20 | 5 | 0 |
| 25 | 4 | 0 |
| 50 | 2 | 0 |
| 75 | 1 | 25 |
| 100 | 1 | 0 |

However, as noted above, in some instances a 20 MHz Bandwidth at 15 KHz sub-carrier spacing can sometimes have 106 PRBs. In such an instance, the number of subchannels and number of remaining PRBs, if any, could change, as identified below in Table 2:

| | No of sub-channels in a | Remaining |
|---|---|---|
| | resource pool with | PRBs |
| Subchannel | 20 MHz BW (106PRBs | (less than the |
| size (PRBs) | @15 KHz SCS) | subchannel size) |
| 10 | 10 | 6 |
| 12 | 8 | 10 |
| 15 | 7 | 1 |
| 20 | 5 | 6 |
| 25 | 4 | 6 |
| 50 | 2 | 6 |
| 75 | 1 | 31 |
| 100 | 1 | 6 |

Table 3, below, alternatively provides a number of subchannels and a number of remaining PRBs for a case including a 20 MHz Bandwidth at 30 KHz sub-carrier spacing, which assumes a resource pool having 50 PRBs.

| | No of sub-channels in a | Remaining PRBs |
|---|---|---|
| Subchannel | resource pool with | (Resource pool is not a |
| size | 20 MHZ BW (50PRBs | multiple of subchannel |
| (PRBs) | @30 KHz SCS) | size) |
| 10 | 5 | 0 |
| 12 | 4 | 2 |
| 15 | 3 | 5 |
| 20 | 2 | 10 |
| 25 | 2 | 0 |
| 50 | 1 | 0 |

Still Further, the Values Change as Follows, if You Assume that the Resource Pool has 51 PRBs, as Identified in Table 4, Below.

| | No of sub-channels in a | Remaining PRBs |
|---|---|---|
| Subchannel | resource pool with | (Resource pool is not a |
| size | 20 MHZ BW (51PRBs | multiple of subchannel |
| (PRBs) | @30 KHz SCS) | size) |
| 10 | 5 | 1 |
| 12 | 4 | 3 |
| 15 | 3 | 6 |
| 20 | 2 | 11 |
| 25 | 2 | 1 |
| 50 | 1 | 1 |

Correspondingly, depending upon the circumstances, there are many instances in which a resource block set after a set of sub-channel are defined can have a number of remaining PRBs that are not part of a defined sub-channel. For example, for a resource pool size of 100 PRBs, with a subchannel size of 12 PRBs, the number of remaining PRBs is 4. In at least one embodiment, these remaining PRBs can be aggregated across multiple resource block sets, so as to form a larger number of available PRBs for use in assigning to a particular purpose.

Resource Pool Configured with Integer Multiple of RBset/LBT Subbands:

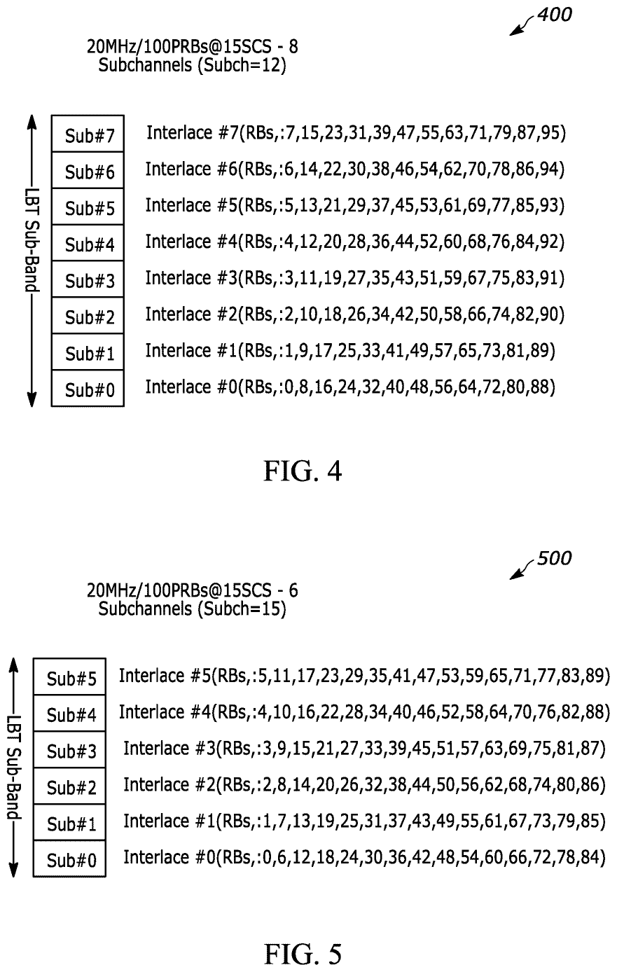

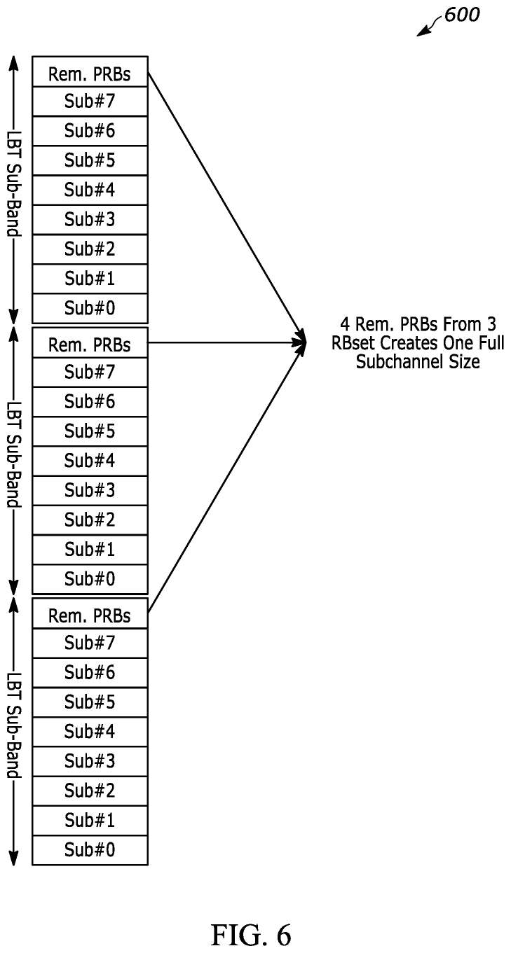

When a resource pool is configured with multiple RBsets, the remaining PRBs from each of the RBset may be combined from which it may be possible to create a full subchannel size. In one example, for subchannel size of 12, there are 8 subchannels in a RBset and there are 4 remaining PRBs as shown in Table 1. An exemplary interlacing of these 8 subchannels is illustrated in FIG. 4. FIG. 4 illustrates an exemplary interlace mapping 400 for a 100 physical resource block set of a 20 MHz channel, which includes 8 subchannels, each having a size of 12 resource blocks. FIG. 5 illustrates a further exemplary interlace mapping 500 for a 100 physical resource block set of a 20 MHz channel, which includes 6 subchannels, each having a size of 15 resource blocks. The 4 remaining PRBs, as provided relative to the example illustrated in FIG. 4, from each of 3 RBsets could be combined to form a new subchannel size of 12, as shown in FIG. 6, which can be used for scheduling PSCCH/PSSCH. FIG. 6 illustrates an aggregated subchannel mapping 600 for three physical resource block sets.

Thus, a new subchannel number is created using the remaining PRBs from one or more RBsets and may contain RBs for interlacing configuration from a RBset. The remaining PRBs in each RBset maybe equally spread across entire RBset instead of occupying an edge of a RBset. In one example, the 4 remaining PRBs of subchannel size 12 in a RBset instead of occupying RBs: #96, #97, #98, #99, may occupy RBs: #3, #33, #66, #99 thus equally spreading across within a RBset to help better meet the OCB requirement. In another example, the 4 PRBs*3 RBset of remaining PRBs of subchannel size 12 may be equally spread across all 3 RBset belonging to a resource pool such as RBs: #24, #49, #74, #99, #124, #149, #174, #199, #224, #249, #274 to help better meet the OCB requirement.

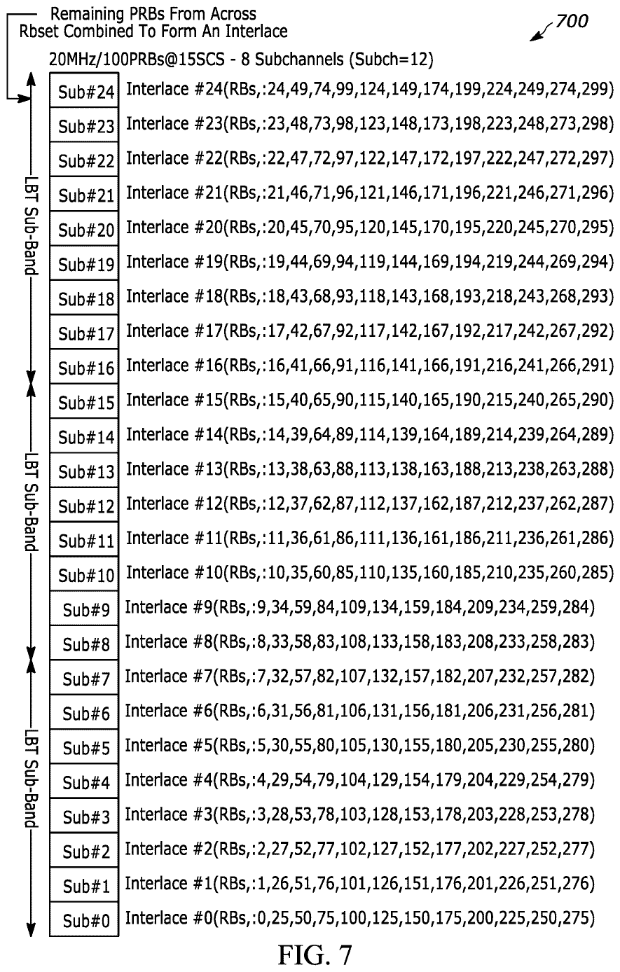

The interlacing configuration may be performed in at least a couple of ways:
1. In interlaced RB based transmission, each interlace may contain RBs within a RBset as shown in FIG. 4. Interlace may contain PRBs equally spaced within a RBset.
   Option 1: (Combined) Remaining PRBs which are equally spaced within each RBset may be combined with other RBsets within a resource pool to form a new subchannel size. The interlacing configuration containing remaining PRBs may contain equally spaced RBs within a RBset or across a combined RBset in a resource pool.
   Option 2: (not combining) The remaining PRBs which are equally spaced within each RBset may form a new subchannel, where the new subchannel size may have a different (irregular PRBs) subchannel size from other subchannel size configuration in a resource pool. In one example for the subchannel size of 12 the subchannel formed from a remaining PRBs may be 4 whereas the subchannel size configured in a resource pool may be 12.
2. In interlaced RB based transmission, since the resource pool occupies integer multiples of RBset, the interlaces may contain equally spaced RBs across RBset as shown in FIG. 7 or the interlace may contain remaining RBs within a RBset. FIG. 7 illustrates an interlacing configuration 700 for the defined subchannels for three aggregated physical resource block sets. Each interlace may contain RBs equally spaced across all RBsets as shown in FIG. 7 or each interlace may contain RBs equally spaced within a RBset as shown in FIG. 4.
   Remaining PRBs which are equally spaced across RBset belonging to a resource pool may be combined to form a new subchannel size.
   When an interlace configuration contains equally spaced RBs across RBset belonging to a resource pool then the interlace may be used when LBT is successful in all the RBset belonging to a resource pool, the transmission may not be performed even if the LBT is partially successful in one of the RBset.
   When an interlace configuration contains equally spaced RBs within a RBset,
      i. The interlace may contain remaining PRBs within a RBset with a different subchannel size and the sidelink transmission is performed when the LBT is successful in that RBset,
      ii. The interlace may contain combined remaining PRBs from across all RBset belonging to a resource pool and the sidelink transmission may be performed when LBT is successful in all the RBset in the resource pool, the transmission may not be performed even if the LBT is partially successful in one of the RBset.

According to a further embodiment,
Option 1: The interlacing indices, X bits where X represent number of subchannels present in each RBset or across RBset in a resource pool to indicate all possible interlace combination.
Option 2: X bits, where

$$X = ⌈ {log}_{2} ( \frac{N ( N + 1 )}{2} ) ⌉$$

where N is the number of subchannels present in each RBset or across RBset in a resource pool indicating the starting interlace index and the number of contiguous interlace indices (RIV) and the remaining RIVs could be used to indicate specific pre-defined interlace combination.
The interlace from new sub-channel size created from remaining PRBs from one or more RBsets may be indicated using this remaining RIVs
The interlace from new subchannel size created from remaining PRBs from one or more RBset may be indicated in combination with other interlaces using the remaining RIVs.
The interlace from new subchannel size created from remaining PRBs from one or more RBsets may be indicated in combination with the other interlace using the RIV values from

$$0 … [ \frac{N ( N + 1 )}{2} ] - 1$$

The subchannel index of the new subchannel size created from remaining PRBs from one or more RBset may be placed anywhere within subchannel indices of a RBset. In one example, the last subchannel index may be allocated for this new subchannel size and in another example, the middle subchannel index may be allocated for this new subchannel size. The placement of this new subchannel size in the subchannel index may have an impact on the overall RBs allocated to a UE. For example, when starting interlace and the contiguous interlace index are reported the placement of new subchannel may impact the overall resource block allocated to a UE.

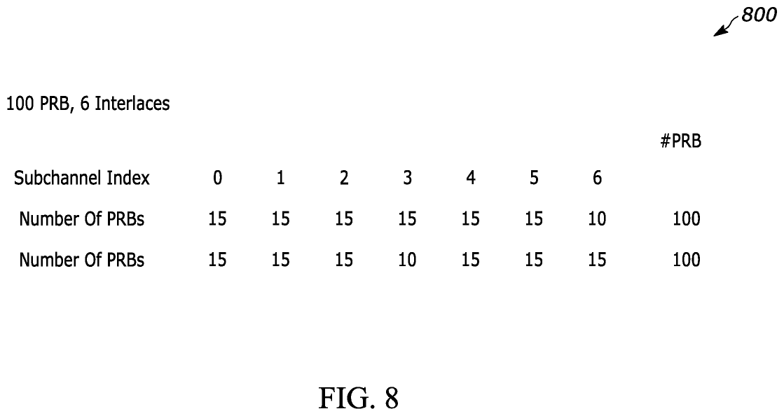

FIG. 8 illustrates a table highlighting multiple examples of the presence and position of s subchannel index in a resource block set, including a first example where the remaining bits are positioned at the edge of a resource block set, and a further example, where the remaining bits are positioned in the middle of the resource block set.

In another implementation, the new channel size with irregular PRBs may be excluded from any resource assignment to a UE and the placement of the irregular PRBs may be at the center of the LBT subband.

Correspondingly, in accordance with the present application, a new subchannel number can be created using the remaining PRBs from one or more RBsets and may contain RBs for an interlacing configuration from one or more RBsets. The remaining PRBs in each RBset may spread across entire RBset instead of occupying an edge of the RBset.

Further, the new channel size created from the remaining PRBs from one or more RBsets may be indicated using the specific pre-defined interlace combination provided by a remaining RIV. The new channel size created from remaining PRBs from one or more RBsets may be indicated in combination with the other interlace combination.

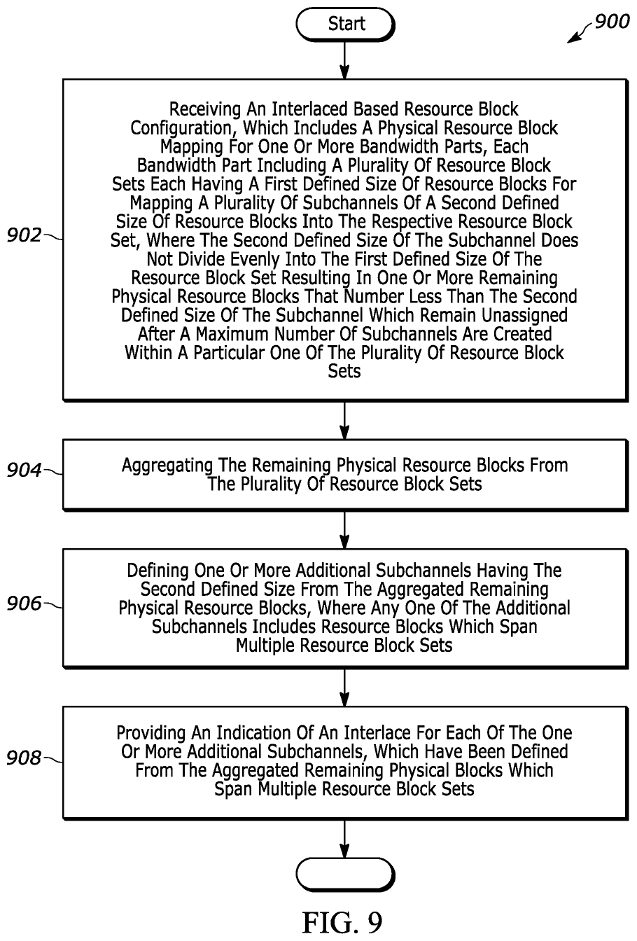

FIG. 9 illustrates a flow diagram 900 of a method in a user equipment. The method includes receiving 902 an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The remaining physical resource blocks from the plurality of resource block sets are aggregated 904. One or more additional subchannels, which have the second defined size, are defined 906 from the aggregated remaining physical resource blocks, where any one of the additional subchannels includes resource blocks which span multiple resource block sets. An indication of an interlace is provided 908 for each of the one or more additional subchannels, which have been defined from the aggregated remaining physical blocks which span multiple resource block sets.

In some instances, the interlaced based resource configuration can be received from a network.

In some instances, the interlaced based resource configuration can be received as part of a resource pool pre-configuration for an unlicensed sidelink carrier.

In some instances, a new channel size can be created, which can include the aggregated remaining physical resource blocks from the plurality of resource block sets, and the indication of an interlace being provided can be for the new channel size being created. In some of these instances, the interlace for the new channel size created from the aggregated remaining physical resource blocks from the plurality of resource block sets can be indicated using a specific predefined interlace combination provided by one of remaining contiguous interlace indices (RIV).

In some instances, a new channel size can be created, which includes the defined subchannels, which are formed from resource blocks from a single resource block set, and the one or more additional subchannels, which are formed from resource blocks which span multiple resource block sets.

In some instances, the subchannels can be for use as part of a physical sidelink control channel.

In some instances, the subchannels can be for use as part of a physical sidelink shared channel.

In some instances, the remaining physical resource blocks can occupy an edge of the resource block set.

In some instances, the remaining physical resource blocks can occupy a group of resource blocks in a center of the resource block set.

In some instances, the remaining physical resource blocks can be spread across the resource block set. In some of these instances, the remaining physical resource blocks can be spread equally across the resource block set. Further, the aggregated remaining physical resource blocks can be spread equally across the plurality of resource block sets from which the remaining physical resource blocks are aggregated.

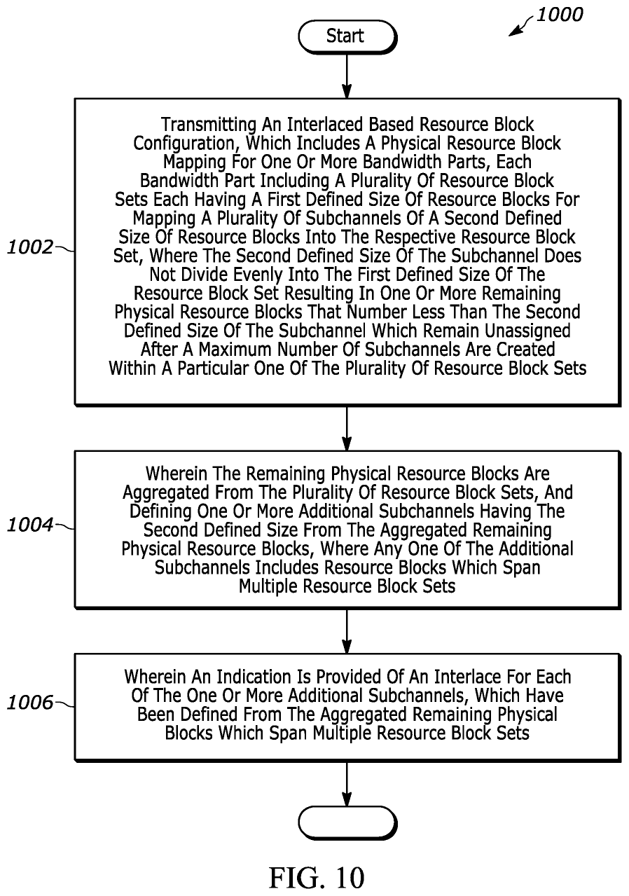

FIG. 10 illustrates a flow diagram 1000 of a method in a network entity. The method includes transmitting 1002 an interlaced based resource block configuration, which includes a physical resource block mapping for one or more bandwidth parts. Each bandwidth part includes a plurality of resource block sets each having a first defined size of resource blocks for mapping a plurality of subchannels of a second defined size of resource blocks into the respective resource block set, where the second defined size of the subchannel does not divide evenly into the first defined size of the resource block set. This results in one or more remaining physical resource blocks that number less than the second defined size of the subchannel which remain unassigned after a maximum number of subchannels are created within a particular one of the plurality of resource block sets. The remaining physical resource blocks are aggregated from the plurality of resource block sets, and one or more additional subchannels having the second defined size are defined from the aggregated remaining physical resource blocks, where any one of the additional subchannels includes resource blocks which span multiple resource block sets 1004. An indication is provided of an interlace for each of the one or more additional subchannels, which have been defined from the aggregated remaining physical blocks which span multiple resource block sets 1006.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

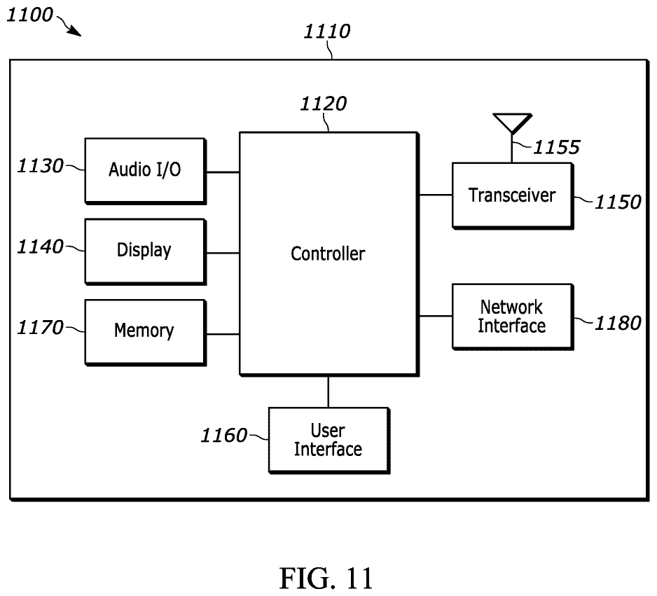

FIG. 11 is an example block diagram of an apparatus 1100, such as the wireless communication device 110, according to a possible embodiment. The apparatus 1100 can include a housing 1110, a controller 1120 within the housing 1110, audio input and output circuitry 1130 coupled to the controller 1120, a display 1140 coupled to the controller 1120, a transceiver 1150 coupled to the controller 1120, an antenna 1155 coupled to the transceiver 1150, a user interface 1160 coupled to the controller 1120, a memory 1170 coupled to the controller 1120, and a network interface 1180 coupled to the controller 1120. The apparatus 1100 can perform the methods described in all the embodiments.

The display 1140 can be a viewfinder, a liquid crystal display (LCD), a light emitting diode (LED) display, a plasma display, a projection display, a touch screen, or any other device that displays information. The transceiver 1150 can include a transmitter and/or a receiver. The audio input and output circuitry 1130 can include a microphone, a speaker, a transducer, or any other audio input and output circuitry. The user interface 1160 can include a keypad, a keyboard, buttons, a touch pad, a joystick, a touch screen display, another additional display, or any other device useful for providing an interface between a user and an electronic device. The network interface 1180 can be a Universal Serial Bus (USB) port, an Ethernet port, an infrared transmitter/receiver, an IEEE 1394 port, a WLAN transceiver, or any other interface that can connect an apparatus to a network, device, or computer and that can transmit and receive data communication signals. The memory 1170 can include a random access memory, a read only memory, an optical memory, a solid state memory, a flash memory, a removable memory, a hard drive, a cache, or any other memory that can be coupled to an apparatus.

The apparatus 1100 or the controller 1120 may implement any operating system, such as Microsoft Windows®, UNIX®, or LINUX®, Android™, or any other operating system. Apparatus operation software may be written in any programming language, such as C, C++, Java or Visual Basic, for example. Apparatus software may also run on an application framework, such as, for example, a Java® framework, a .NET® framework, or any other application framework. The software and/or the operating system may be stored in the memory 1170 or elsewhere on the apparatus 1100. The apparatus 1100 or the controller 1120 may also use hardware to implement disclosed operations. For example, the controller 1120 may be any programmable processor. Disclosed embodiments may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 1120 may be any controller or processor device or devices capable of operating an apparatus and implementing the disclosed embodiments. Some or all of the additional elements of the apparatus 1100 can also perform some or all of the operations of the disclosed embodiments.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of,” “at least one selected from the group of,” or “at least one selected from” followed by a list is defined to mean one, some, or all, but not necessarily all of, the elements in the list. The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

What is claimed is:

1. A user equipment (UE) for wireless communication, comprising:
at least one memory; and
at least one processor coupled with the at least one memory and operable to cause the UE to:
receive an interlaced-based resource block (RB) configuration, which includes a physical resource block (PRB) mapping for one or more bandwidth parts (BWPs), each BWP including a plurality of RB sets each having a first defined size of RBs for mapping a plurality of subchannels of a second defined size of RBs into a respective RB set, where the second defined size of a subchannel does not divide evenly into the first defined size of a RB set resulting in one or more remaining PRBs that number less than the second defined size of the subchannel which remain unassigned after a maximum number of subchannels are created within a particular one of the plurality of RB sets;
aggregate remaining PRBs from the plurality of RB sets;
define one or more additional subchannels having the second defined size from the aggregated remaining PRBs, where at least one of the one or more additional subchannels includes RBs which span multiple RB sets; and
provide an indication of an interlace for each of the one or more additional subchannels, which have been defined from the aggregated remaining physical blocks which span multiple RB sets.

2. The UE of claim 1, wherein the interlaced-based RB configuration is received from a network.

3. The UE of claim 1, wherein the interlaced-based RB configuration is received as part of a resource pool pre-configuration for an unlicensed sidelink carrier.

4. The UE of claim 1, wherein a new channel size is created, which includes the aggregated remaining PRBs from the plurality of RB sets, and the indication of an interlace being provided is for the new channel size being created.

5. The UE of claim 4, wherein the interlace for the new channel size created from the aggregated remaining PRBs from the plurality of RB sets is indicated using a specific predefined interlace combination provided by one of remaining contiguous interlace indices (RIV).

6. The UE of claim 1, wherein a new channel size is created, which includes the plurality of subchannels, which are formed from a single RB set, and the one or more additional subchannels, which are formed from RBs which span multiple sets.

7. The UE of claim 1, wherein the plurality of subchannels are for use as part of a physical sidelink control channel.

8. The UE of claim 1, wherein the plurality of subchannels are for use as part of a physical sidelink shared channel.

9. The UE of claim 1, wherein the remaining PRBs occupy an edge of the RB set.

10. The UE of claim 1, wherein the remaining PRBs occupy a group of RBs in a center of the RB set.

11. The UE of claim 1, wherein the remaining PRBs are spread across the RB set.

12. The UE of claim 11, wherein the remaining PRBs are spread equally across the RB set.

13. The UE of claim 12, wherein the aggregated remaining PRBs are spread equally across the plurality of RB sets from which the remaining PRBs are aggregated.

14. (canceled)

15. (canceled)

16. (canceled)

17. (canceled)

18. (canceled)

19. A network entity for wireless communication, comprising:
at least one memory; and
at least one processor coupled with the at least one memory and operable to cause the network entity to:
transmit an interlaced-based resource block (RB) configuration, which includes a physical resource block (PRB) mapping for one or more bandwidth parts (BWPs), each BWP including a plurality of RB sets each having a first defined size of RBs for mapping a plurality of subchannels of a second defined size of RBs into a respective RB set, where the second defined size of a subchannel does not divide evenly into the first defined size of a RB set resulting in one or more remaining PRBs that number less than the second defined size of the subchannel which remain unassigned after a maximum number of subchannels are created within a particular one of the plurality of RB sets;
wherein remaining PRBs are aggregated from the plurality of RB sets, and defining one or more, additional subchannels having the second defined size from the aggregated remaining PRBs, where at least one of the one or more additional subchannels includes RBs which span multiple RB sets; and
wherein an indication is provided of an interlace for each of the one or more additional subchannels, which have been defined from the aggregated remaining physical blocks which span multiple RB sets.

20. A method performed by a user equipment (UE), the method comprising:
receiving an interlaced-based resource block (RB) configuration, which includes a physical resource block (PRB) mapping for one or more bandwidth parts (BWPs), each BWP including a plurality of RB sets each having a first defined size of RBs for mapping a plurality of subchannels of a second defined size of RBs into a respective RB set, where the second defined size of a subchannel does not divide evenly into the first defined size of a RB set resulting in one or more remaining PRBs that number less than the second defined size of the subchannel which remain unassigned after a maximum number of subchannels are created within a particular one of the plurality of RB sets;
aggregating remaining PRBs from the plurality of RB sets;
defining one or more additional subchannels having the second defined size from the aggregated remaining PRBs, where at least one of the one or more additional subchannels includes RBs which span multiple RB sets; and
providing an indication of an interlace for each of the one or more additional subchannels, which have been defined from the aggregated remaining physical blocks which span multiple RB sets.

21. The method of claim 20, wherein the interlaced-based RB configuration is received from a network.

22. The method of claim 20, wherein the interlaced-based RB configuration is received as part of a resource pool pre-configuration for an unlicensed sidelink carrier.

23. The method of claim 20, wherein a new channel size is created, which includes the aggregated remaining PRBs from the plurality of RB sets, and the indication of an interlace being provided is for the new channel size being created.

24. The method of claim 23, wherein the interlace for the new channel size created from the aggregated remaining PRBs from the plurality of RB sets is indicated using a specific predefined interlace combination provided by one of remaining contiguous interlace indices (RIV).

25. A method performed by a network entity, the method comprising:
transmitting an interlaced-based resource block (RB) configuration, which includes a physical resource block (PRB) mapping for one or more bandwidth parts (BWPs), each BWP including a plurality of RB sets each having a first defined size of RBs for mapping a plurality of subchannels of a second defined size of RBs into a respective RB set, where the second defined size of a subchannel does not divide evenly into the first defined size of a RB set resulting in one or more remaining PRBs that number less than the second defined size of the subchannel which remain unassigned after a maximum number of subchannels are created within a particular one of the plurality of RB sets;
wherein remaining PRBs are aggregated from the plurality of RB sets, and defining one or more additional subchannels having the second defined size from the aggregated remaining PRBs, where at least one of the one or more additional subchannels includes RBs which span multiple RB sets; and
wherein an indication is provided of an interlace for each of the one or more additional subchannels, which have been defined from the aggregated remaining physical blocks which span multiple RB sets.
